(19) United States
(12) Patent Application Publication
(10) Pub. No.: US 2006/0219507 A1
(43) Pub. Date: Oct. 5, 2006

(54) Cylinder, in particular for a motor vehicle hydraulic brake system

(76) Inventors: Peter Drott, Frankfurt/M (DE); Harald König, Ober-Mörlen (DE); Udo Jungmann, Mörfelden (DE); Andreas Bischoff, Bad Vilbel (DE)

Correspondence Address: Gerlinde M Nattler;Craig Hallacher, Continental Teves Inc, One Continental Drive, Auburn Hills, MI, 48326, US

(21) Appl. No.: 10/568,900

(22) PCT Filed: Aug. 4, 2004
(86) PCT No.: PCT/EP04/51703

§ 371 Date: Feb. 17, 2006

(30) Foreign Application Priority Data
Aug. 18, 2003 (DE) 10338416.2
Mar. 26, 2004 (DE) 102004014867.8

(51) Int. Cl. F16F 9/36

(52) U.S. Cl. 188/322.17; 188/322.16

(57) ABSTRACT

A cylinder, in particular for motor vehicle hydraulic brake systems, i includes at least one plunger piston (3) displaceable in a housing (2), at least one circular sealing collar (5) provided in an annular groove (4) of the housing (2) and having a dynamically applied inside sealing lip (6) which abuts with a first sealing surface (8) on the plunger piston (3), and a statically applied outside sealing lip (7) which abuts with a second sealing surface (9) on a bottom (10 of the annular groove (4), as well as a collar back (17).

The collar back (17) has an uneven design and includes at least one circumferential sealing surface (18; 24).

### BACKGROUND OF THE INVENTION

The present invention relates to a cylinder, in particular for motor vehicle hydraulic brake systems, including at least one plunger piston displaceable in a housing, at least one circular sealing collar provided in an annular groove of the housing and having a dynamically applied inside sealing lip which abuts with a first sealing surface on the plunger piston, and a statically applied outside sealing lip which abuts with a second sealing surface on a bottom of the annular groove, as well as a collar back.

DE 101 20 913 A1 discloses a cylinder of this type. The cylinder includes a sealing collar with a dynamically applied inside sealing lip, a statically applied outside sealing lip, as well as a collar back of an uneven design. It is disadvantageous in this application that the sealing collar with the collar back can get stuck on a lateral wall of the annular groove.

The sealing collar performs the task of a non-return valve which, on the one hand, seals pressure chambers when the cylinder is actuated and, thus, allows pressure to develop in them, while, on the other hand, it allows fluid replenishment from a supply reservoir by way of the cylinder in the event of an intervention of driving dynamics control, with pressure fluid flowing over the outside sealing lip of the sealing collar.

The sealing function of the sealing lips must be safeguarded for fail-free operation of the cylinder. As it is required that the statically stressed outside sealing lip has a relatively elastic design for allowing fluid overflow, leakage of the sealing surface at the outside sealing lip can be caused by damages or contaminants, as tests showed.

In view of the above, an object of the invention is to provide a cylinder that is improved to such effect.

### SUMMARY OF THE INVENTION

According to the invention, this object is achieved in that the back of the collar has an uneven design and includes at least one circumferential sealing surface. This sealing surface represents a redundancy with respect to the sealing surface of the outside sealing lip, while the robustness of the cylinder is improved in addition. Another advantage of the sealing surface at the collar back is achieved in that a defined pressure fluid volume is enclosed in an outside heel area of the sealing collar between the second sealing surface at the outside sealing lip and the sealing surface at the collar back, whereby displacement of the sealing collar in the direction of the bottom of the annular groove is prevented. This fact ensures the abutment of the sealing surfaces.

In a favorable improvement of the invention, the collar back includes a circumferential circular surface which is interrupted by radial, groove-type recesses only in part so that a circular, circumferential sealing surface without recesses is achieved in an outside fringe area. The groove-type recesses improve the fluid flow over the outside sealing lip in the case of a driving dynamics control intervention because the flow cross-section is increased.

A particularly straightforward embodiment of the sealing collar is obtained when the collar back includes a circumferential sealing bead as a sealing surface.

Another favorable embodiment of the invention arranges for two circumferential sealing surfaces on the back of the collar. This provides an additional redundancy of the sealing surfaces, and it is preferred that the collar back includes two circumferential sealing beads as sealing surfaces.

In a favorable improvement of the invention, the sealing collar has an axial projection between the inside sealing lip and the outside sealing lip, the projection towering over the sealing lips in an axial direction. The projection enhances the robustness of the sealing collar, on the one hand, and prevents, on the other hand, that the dynamically stressed inside sealing lip gets jammed in a slot between the housing and the plunger piston and the statically stressed outside sealing lip is prevented from deforming due to striking against a lateral wall of the annular groove.

The invention will be explained in the following by way of the accompanying drawings, making reference to embodiments.

### BRIEF DESCRIPTION OF THE DRAWINGS

In a highly schematic view in the drawings:

FIG. 1 is a partial longitudinal cross-sectional view of a first embodiment of a cylinder according to the invention;

FIG. 2 is a partial longitudinal cross-sectional view of a second embodiment of a cylinder according to the invention;

FIG. 3 is a three-dimensional view of a sealing collar of a third embodiment of a cylinder according to the invention; and

FIG. 4 is a partial longitudinal cross-sectional view of the sealing collar of FIG. 3.

### DETAILED DESCRIPTION OF THE DRAWINGS

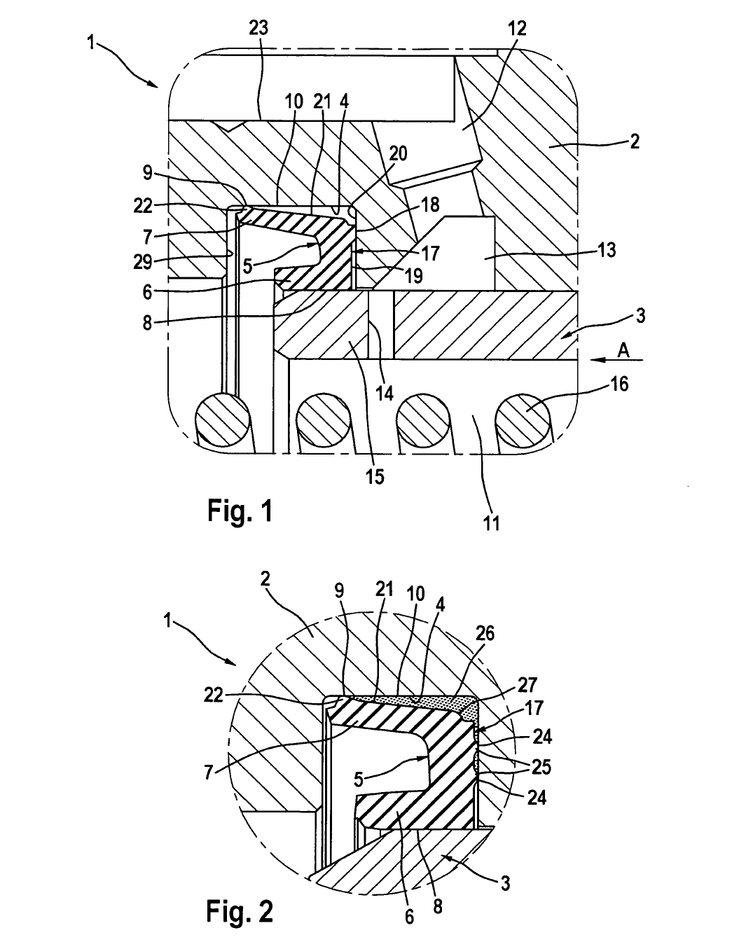

FIG. 1 shows in a partial view those parts of a first embodiment of a cylinder which are essential for the invention, the said cylinder being e.g. configured as master cylinder 1 in a plunger-type and tandem-type construction for use in motor vehicle hydraulic brake systems. The mode of operation of a master cylinder 1 of this type is principally known so that only the features that are essential for the invention will be described mainly. Further, the two serially arranged pressure circuits of the master cylinder 1 in tandem-type construction are almost identical in terms of their design and mode of operation so that only one pressure circuit is described.

The pressure circuit of the master cylinder 1 being shown in a partial view comprises a plunger piston 3 displaceable in a housing 2, and a circular sealing collar 5 is arranged in an annular groove 4 of the housing 2, being provided with a dynamically applied inside sealing lip 6 as well as with a statically applied outside sealing lip 7. The dynamically applied inside sealing lip 6 abuts with a first sealing surface 8 on the plunger piston 3, and the statically applied outside sealing lip 7 abuts with a second sealing surface 9 on a bottom 10 of the annular groove 4.

In a non-actuated condition of the master cylinder 1 illustrated in FIG. 1, a pressure chamber 11 is connected to an unpressurized supply tank (not shown) by way of a pressure fluid channel 12 and a filling notch 13 in the housing 2 as well as by way of a bore 14 in the bowl-type wall 15 of the plunger piston 3. The plunger piston 3 is biased by means of a compression spring 16 in this arrangement.

The plunger piston 3 is displaced in the actuating direction A for actuation purposes. As this occurs, the movement of the plunger piston 3 is transmitted by way of compression spring 16 to the second pressure circuit (not shown). As soon as the bore 14 is disposed in the area of the sealing collar 5, the so-called lost travel of the master cylinder 1 has been covered because pressure fluid can no longer propagate from the filling notch 13 through the bore 14 into the pressure chamber 11. The connection between the pressure chamber 11 and the supply tank is interrupted. Pressure develops in the pressure chamber 11 which is now sealed by means of the sealing collar 5. The pressure developing in the pressure chamber 11 retains the inside sealing lip 6 and the outside sealing lip 7 with their sealing surfaces 8, 9 in abutment on the plunger piston 3 or the bottom 10 of the annular groove 4, respectively, whereby sealing is provided. Simultaneously, a back of the collar 17 of the sealing collar 5 with a sealing surface 18 is urged against a first lateral wall 20 of the annular groove 4 due to the pressure buildup. This allows an actuation of wheel brakes (not shown) split-up in brake circuits, the said wheel brakes being connected hydraulically to the pressure chambers of the master cylinder 1 by way of a hydraulic unit with solenoid valves so that electronically controlled brake actuation (ABS) or driving stability control (ESP) is rendered possible.

It may be necessary in an ESP intervention, with plunger piston 3 actuated, to additionally aspirate pressure fluid from the supply tank via the pressure chamber 11 in the direction of the wheel brakes, which is preferably done by using a pump. The inlet of the pump can be connected optionally to the pressure chambers of the master cylinder 1 or to the wheel brakes in order to supply fluid in the direction of the wheel brakes or in the direction of the master cylinder 1 (return delivery principle). To this end, fluid flows over the outside sealing lip 7 of the sealing collar 5 because it folds down in the direction of the inside sealing lip 6 on account of the aspiration pressure, with the result that the sealing surface 9 no longer bears against the bottom 10 of the annular groove.

As can be seen in FIG. 1, the sealing collar 5 at the collar back 17 includes the circumferential, circular sealing surface 18, which represents a redundancy regarding the second sealing surface 9 of the outside sealing lip 7 because the second sealing surface 9, which is provided at a circumferential bead 22 that is arranged on an outside surface 21 of the outside sealing lip 7 can become leaky due to damage or contaminants in the pressure fluid.

The collar back 17 is designed as a circumferential, circular surface which is only partly interrupted by radial groove-type recesses 19. The result is a circular, circumferential surface without recesses which represents the sealing surface 18 and is located in an outside fringe area 31. The purpose of the groove-type recesses 19 is, on the one hand, to improve the filling of the pressure chamber 11 by way of an increase in the flow cross-section when pressure fluid flows over the outside sealing lip 7, on the one hand, while the recesses prevent the sleeve collar 17 from becoming attached by suction on the first lateral wall 20 of the annular groove 4, on the other hand.

In the event of ESP intervention, as has been described hereinabove, pressure fluid is replenished by means of a pump out of the supply reservoir, which is arranged by means of reservoir sockets (not shown) in reservoir bores 23 of the housing 2, through the pressure fluid channel 12, the filling notch 13, a small slot between housing 2 and plunger piston 3, the outside sealing lip 7 folded down in the direction of the inside sealing lip 6, and the pressure chamber 11 in the direction of the wheel brakes. The second sealing surface 9 becomes ineffective then due to the outside sealing lip 7 folding down. The sealing surface 18 at the collar back 17 is removed from the lateral wall 20 due to the suction pressure because the sealing collar 5 is able to displace in the annular groove 4 slightly in the actuating direction A. The flow cross-section increases due to the radial groove-type recesses 19 so that a sufficient amount of pressure fluid can flow over the sealing collar 5.

FIG. 2 shows in a partial view the parts essential for the invention of a second embodiment of a cylinder, designed as a master cylinder 1 in a plunger-type and tandem-type construction for use in motor vehicle brake systems.

As can be seen in FIG. 2, the sealing collar of this embodiment differs from the sealing collar described in FIG. 1 only as regards the design of the collar back 17. Therefore, equal or identical components in FIG. 2 have been assigned the reference numerals used in FIG. 1 and will not be explained in detail.

In contrast to the embodiment described with respect to FIG. 1, the collar back 17 of the second embodiment includes two sealing beads 25 as sealing surfaces 24.

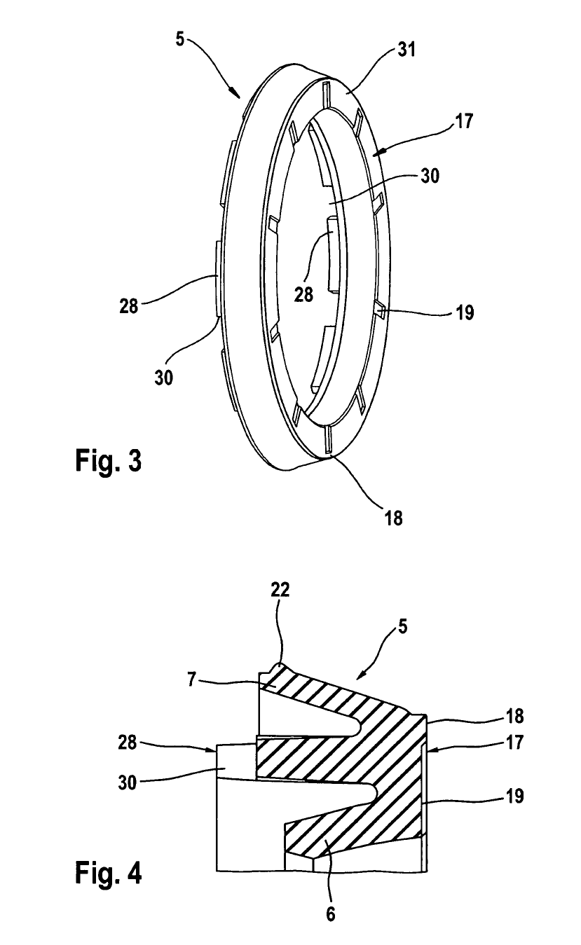

In addition to redundancy, another advantage of the sealing surfaces 24 on the collar back 17 becomes apparent herein. Between the second sealing surface 9 at the outside sealing lip 7 and the sealing surfaces 24 at the collar back 17, a defined pressure fluid volume 26 is enclosed in an outside heel area 27 of the sealing collar 5 when the master cylinder 1 is actuated. This prevents displacement of the sealing collar 5 in the direction of the bottom 10 of the annular groove 4 and ensures the reliable abutment of the inside sealing lip 6 and the outside sealing lip 7 on the plunger piston 3 and on the bottom 10 of the annular groove 4, respectively of course, this advantage is also achieved in the embodiment described with regard to FIG. 1 and the embodiment according to FIGS. 3 and 4 that will be described hereinbelow.

FIGS. 3 and 4 show a sealing collar of a third embodiment of a cylinder of the invention which is e.g. configured as a master cylinder 1, and FIG. 3 shows a three-dimensional view of the sealing collar 5, while FIG. 4 shows a partial longitudinal cross-sectional view of the sealing collar 5.

The sealing collar 5 of this embodiment differs from the sealing collar of FIG. 1 only in that an axial projection 28 is provided between the inside sealing lip 6 and the outside sealing lip 7 which towers above the two sealing lips 6, 7 in an axial direction. Therefore, like or identical components in FIGS. 3 and 4 have been characterized by the reference numerals of FIG. 1 and will not be explained in detail.

The projection 28 enhances the robustness of the sealing collar 5, on the one hand, and prevents, on the other hand, that the dynamically stressed inside sealing lip 6 gets jammed in a slot between housing 2 and plunger piston 3 and that the statically stressed outside sealing lip 7 can be deformed by striking against a second lateral wall 29 of the annular groove 4 that is shown in FIG. 1. Radial apertures 30 of the projection 28 ensure that pressure fluid can flow via the sealing collar 5 into the pressure chamber when the projections 28 moves to abut on the second lateral wall 29.

FIG. 4 renders the circular design of the sealing collar 5 apparent, and it becomes obvious that the collar back 17 is designed as a circumferential, circular surface which is only partly interrupted by the radial groove-type recesses 19 so that the circumferential, circular sealing surface 18 is placed in the outside fringe area 31 of the collar back 17. The recesses 19, as can be taken from FIG. 4, are arranged on the collar back 17 at equal distances from each other as well as like a star. However, other versions of arrangement are also feasible.

A projection 28 described and illustrated according to FIGS. 3 and 4 can be foreseen also with the sealing collars of the first and second embodiments.

### LIST OF REFERENCE NUMERALS

1 master cylinder
2 housing
3 plunger piston
4 annular groove
5 sealing collar
6 inside sealing lip
7 outside sealing lip
8 sealing surface
9 sealing surface
10 bottom
11 pressure chamber
12 pressure fluid channel
13 filling notch
14 bore
15 wall
16 compression spring
17 collar back
18 sealing surface
19 recess
20 lateral wall
21 outside surface
22 bead
23 reservoir bore
24 sealing surface
25 sealing bead
26 pressure fluid volume
27 outside heel area
28 projection
29 lateral wall
30 aperture
32 fringe area
A actuating direction

1-6. (canceled)

7. A cylinder including
at least one plunger piston (3) displaceable in a housing (2), and
at least one circular sealing collar (5) provided in an annular groove (4) of the housing (2) with a dynamically applied inside sealing lip (6) which abuts with a first sealing surface (8) on the plunger piston (3) and a statically applied outside sealing lip (7) which abuts with a second sealing surface (9) on a bottom (10) of the annular groove (4), as well as a collar back (17), wherein the collar back (17) has an uneven design and includes at least one circumferential sealing surface (18; 24).

8. The cylinder as claimed in claim 7,
wherein the collar back (17) includes a circumferential circular surface which is interrupted by radial, groove-type recesses (19) only in part so that a circular, circumferential sealing surface (18) without recesses is achieved in an outside fringe area (31) of the collar back (17).

9. The cylinder as claimed in claim 7,
wherein the collar back (17) includes a circumferential sealing bead (25) as a sealing surface (24).

10. The cylinder as claimed in claim 7,
wherein two circumferential sealing surfaces (24) are provided on the collar back (17).

11. The cylinder as claimed in claim 10,
wherein the collar back (17) includes two circumferential sealing beads (25) as sealing surfaces (24).

12. The cylinder as claimed in claim 7
wherein the sealing collar (5) has an axial projection (28) between the inside sealing lip (6) and the outside sealing lip (7), prodtruding beyond the sealing lips (6, 7) in an axial direction.
